(19) United States
(12) Patent Application Publication
(10) Pub. No.: US 2003/0220445 A1
(43) Pub. Date: Nov. 27, 2003

(54) Polyisocyanates and polyurethanes containing polymer modifiers, and their use

(76) Inventors: Eduard Mayer, Dormagen (DE); Erhard Michels, Koln (DE); Helmut Meyer, Odenthal (DE); Klaus Pleiss, Bergisch Gladbach (DE)

Correspondence Address: BAYER POLYMERS LLC, 100 BAYER ROAD, PITTSBURGH, PA, 15205, US

(21) Appl. No.: 10/440,654

(22) Filed: May 19, 2003

(30) Foreign Application Priority Data
May 23, 2002 (DE) 10222888.4

(51) Int. Cl. C08K 3/00

(52) U.S. Cl. 524/589

(57) ABSTRACT

The invention relates to polymer-modified polyisocyanates and to polyurethanes prepared therefrom, and to their use in the production of polyurethane molded bodies. The polyisocyanates are modified with thermoplastic vinyl polymers having a number average molecular weight of from 15 to 90 kg/mol.

### BACKGROUND OF THE INVENTION

The invention relates to polymer-modified polyisocyanates, to polyurethanes prepared therefrom, and to their use in the production of polyurethane molded articles.

The production of optionally cellular polyurethane-based molded plastics having a compact surface is part of the prior art (DE-A 40 32 148). Such molded plastics can be produced in soft, semi-rigid and rigid form. The elastomeric, optionally “semi-rigid” polyurethane-based molded articles, in particular, have for many years been used inter alia in the production of shoe soles and other components of shoes.

If it is desired to also use polymer modifiers, for example styrene polymers, in order to achieve particular properties such as increased hardness, special polymer-filled polyether polyols, as are also mentioned in DE-A 40 32 148, or special polymer-filled polyester polyols, as are described, for example, in EP-A 0 250. 351, are indicated. A disadvantage is that commercially available polymers cannot be used, because they are incompatible with the polyols and/or deposit sediment.

An additional disadvantage in the preparation of polyol dispersions is that they can only be stabilized by special techniques; for example, by the concomitant use of macromers containing double bonds, and by in situ polymerization of styrene and acrylonitrile monomers in polyether polyols such as are described in EP-A 780 410. and EP-A 731 118.

Another possible method of incorporating organic fillers, for example polyureas or polyhydrazocarbonamides, into polyols is to react, for example, diisocyanatotoluene (80:20 mixture of the 2,4- and 2,6-isomers) with, for example, hydrazine hydrate in the polyol mixture. These processes, at best, result in cloudy, milky dispersions. These polyols containing organic fillers can then optionally be reacted with a polyisocyanate to form an NCO prepolymer or, alternatively, directly to the finished polyurethane.

The preparation of stabilized isocyanate dispersions by the concomitant use of macromers is described in U.S. Pat. No. 4,695,596 and U.S. Pat. No. 4,772,658. Those processes yield non-transparent isocyanate dispersions which are used in the production of foams, elastomers or adhesives.

It is known from DE-A 41 10 976 that styrene-acrylonitrile-butadiene polymers (ABS) can substantially be used as polymer modifiers in the preparation of modified isocyanates and their conversion to plastics by the isocyanate polyaddition process, a stable milky dispersion of the ABS particles being prepared in the basic polyisocyanate by swelling. A disadvantage is that the transparency of the polyisocyanate is lost and it is not possible to distinguish visually between, for example, crystallized isocyanate and dispersed filler.

It is known from DE-A 4 229 641 that compounds from the group of the polyacrylates, polyacrylate polymers, styrene-acrylonitrile polymers and polystyrenes can be used as additives in the production of thermoplastically moldable polyurethane foams, those compounds being introduced as filler by way of the polyol component(s). In no case has it been found that such additives can be dissolved in the polyisocyanate to yield transparent, sediment-free isocyanate compositions which can then be reacted with the remaining components to form polyurethanes.

A disadvantage of the known processes for the preparation of polyurethanes modified with polymers is that the polymers either deposit sediment in the polyol dispersions, as a result of which the polyol dispersions are difficult to process, or must be stabilized by the additional use of macromers.

### SUMMARY OF THE INVENTION

The object of the present invention was, therefore, to provide polymer-modified polyurethanes which (1) can be prepared simply and without problems, (2) do not contain additional stabilizers that may adversely affect the properties of the polyurethanes, and (3) exhibit a high degree of hardness in addition to good elasticity.

Surprisingly, it has been possible to achieve that object with the particular polymer modifiers described more fully below which are added to the polyisocyanate component and are present therein in dissolved form. Using this transparent solution of the polymer-modified polyisocyanate component, it is possible to prepare elastic polyurethanes which have a high degree of hardness and, additionally, exhibit a markedly improved green strength on processing to molded articles (e.g. shoe soles), which in turn leads to improved behavior on removal from the mold and hence to shorter cycle times.

### DETAILED DESCRIPTION OF THE INVENTION

The invention provides polymer-modified transparent polyisocyanates (PMP) which include the following components:

A) at least one of the following polyisocyanate components:

A1) one or more polyisocyanates having an NCO content of from 15 to 50 wt. %,

A2) one or more so-called modified polyisocyanates having an NCO content of from 12 to 45 wt. % and

A3) one or more isocyanate-containing prepolymers having an NCO content of from 8 to 45 wt. %, which may be produced from

i) A1) and/or A2),

ii) one or more of the following polyol component(s) C)

(1) polyether polyols having OH numbers of from 10 to 149 and functionalities of from 2 to 8,

(2) polyester polyols having OH numbers of from 20 to 280 and functionalities of from 2 to 3, and

(3) polyether ester polyols having OH numbers of from 10 to 149 and functionalities of from 2 to 8,

iii) optionally, one or more chain extenders and/or crosslinkers D) having OH numbers of from 150 to 1870, and

B) at least one thermoplastic vinyl polymer having a number-average molecular weight of from 15 to 90 kg/mol (measured by high-pressure size-exclusion chromatography (HPSEC))

and, optionally, further additives and/or added substances.

The polymer modifier B) is uniformly distributed in the polyurethane product when that polyurethane product has been prepared from the corresponding modified polyisocyanate.

The preparation of the polymer-modified polyisocyanates (PMP) of the present invention can preferably be carried out in any of the following ways:

1. dissolution of the polymer modifier (B) in the isocyanate (A) at from room temperature to 120° C.,

2. dissolution of the polymer modifier (B) in isocyanate (A1) or (A2) at from room temperature to 120° C. and subsequent reaction with components (C) and optionally (D) to form prepolymers,

3. dissolution of the polymer modifier (B) in the isocyanate (A1) and (A2) and simultaneous reaction with components (C) and optionally (D), and

4. dispersion of the polymer modifier (B) in the polyol (C) and optionally component (D) and subsequent reaction with isocyanate (A1) or (A2) to form the prepolymer (A3), dissolution of the polymer modifier (B) taking place at the same time.

In each of preparation methods 1 through 4, it is not necessary for the isocyanate(s) and polyol(s) to be used directly in their total amount. It is also possible for the residual amounts, in this case especially partial amounts of the isocyanate component (A), to be added later for the purpose of completion of the polyurethane formation.

The preparation of the prepolymers is generally carried out at from room temperature to 120° C., preferably at from 60 to 90° C. If aliphatic or cycloaliphatic isocyanates are used or used concomitantly to prepare the prepolymers, the preferred temperature range is from 70 to 110° C. The concomitant use of further additives and/or added substances, such as, for example, catalysts, viscosity regulators, etc., is also possible.

The invention also provides polymer-modified polyurethanes which are obtainable from:

i) the PMP's according to the invention produced from components (A) and (B) and optionally further additives and/or added substances,

ii) one or more polyol and/or polyamine components (C) having a number-average molecular weight of from 800 to 8000 daltons and a functionality of from 1.8 to 3.5 selected from polyether polyols, polyether polyamines, polyester polyols, polyether ester polyols, polycarbonate diols and polycaprolactones,

iii) one or more chain extenders and/or crosslinkers (D) having a number-average molecular weight of from 60 to 400 daltons and functionality of from 2 to 4, in the presence of

iv) optional catalysts (E),

v) optional further additives and/or added agents (F), and

vi) optional water and/or blowing agents.

Preparation methods for polymer-modified polyurethane(s):

The polyurethanes according to the invention can be prepared by the processes described in the literature, for example, the one-shot, the semi-prepolymer or the prepolymer process, with the aid of mixing apparatus known to the person skilled in the art. They are preferably prepared by the prepolymer process.

In the preferred prepolymer process, a polyaddition adduct (PMP) having isocyanate groups is prepared in a first step from the isocyanate component (A) and the polymer modifier (B) dissolved therein, and optionally component (D). In the second step, it is possible to prepare solid PUR elastomers from such prepolymers having isocyanate groups by reaction with polyol components (C) and optionally low molecular weight chain extenders and/or crosslinkers (D). Catalysts (E) and additives and/or added agents (F) may optionally be used both in the isocyanate component (PMP) and in components (C) and (D).

If water or other blowing agents or mixtures thereof are used concomitantly in the second step, microcellular PUR elastomers can be prepared.

For the preparation of the polyurethanes according to the invention, the components are reacted in amounts such that the equivalence ratio of the NCO groups of the polyisocyanates (A) to the sum of the hydrogen atoms, reactive towards isocyanate groups, of components (C) and (D) and of any blowing agents having a chemical action which may have been used, is from 0.8:1 to 1.2:1, preferably, from 0.9:1 to 1.15:1 and most preferably, from 0.95:1 to 1.05:1.

In one method for the preparation of the PUR materials according to the invention, the starting components are homogeneously mixed in the absence of blowing agents, usually at a temperature of from 20 to 80° C., preferably from 25 to 60° C., and the reaction mixture is introduced into an open, optionally temperature-controlled molding tool and then cured. In another method for the preparation of the PUR elastomers according to the invention, the structural components are mixed in the same manner in the presence of one or more blowing agents, preferably water, and introduced into the optionally temperature-controlled molding tool. After filling, the molding tool is closed, and the reaction mixture is allowed to foam with densification, for example with a degree of densification (ratio of the density of the molding to the density of the free foam) of from 1.05 to 8, preferably from 1.1 to 6 and most preferably from 1.2 to 4, to form molded articles. As soon as the molded articles are sufficiently strong, they are removed from the mold. The mold removal times are dependent inter alia on the temperature and geometry of the molding tool and the reactivity of the reaction mixture, and are usually from 1 to 10 minutes.

Compact polyurethane (“PUR”) elastomers according to the invention have, depending inter alia on the content and type of filler, a density of from 0.8 to 1.4 g/cm³, preferably from 0.9 to 1.25 g/cm³. Cellular PUR elastomers according to the invention have densities of from 0.1 to 1.4 g/cm³, preferably from 0.15 to 0.8 g/cm³.

The polyurethanes according to the invention ate especially valuable materials for molding plastics, which are distinguished, compared with conventionally used materials, by an equivalent or even increased hardness, despite the density of the molding being reduced. The materials according to the invention may be used, for example, in the manufacture of components for shoes or of shoe soles of single- or multi-layer construction.

Suitable starting components A) for the process according to the invention are aliphatic, cycloaliphatic, araliphatic, aromatic and heterocyclic polyisocyanates, as are described, for example, by W. Siefken in Justus Liebigs Annalen der Chemie, 562, pages 75 to 136. Examples of such polyisocyanates include those of the formula Q (NCO)ₙ, in which n=from 2 to 4, preferably 2, and Q may represent an aliphatic hydrocarbon radical having from 2 to 18 carbon atoms, preferably from 6 to 10 carbon atoms, a cycloaliphatic hydrocarbon radical having from 4 to 15 carbon atoms, preferably from 5 to 10 carbon atoms, an aromatic hydrocarbon radical having from 6 to 15 carbon atoms, preferably from 6 to 13 carbon atoms, or an araliphatic hydrocarbon radical having from 8 to 15 carbon atoms, preferably from 8 to 13 carbon atoms. Examples are: ethylene diisocyanate; 1,4-tetramethylene diisocyanate; 1,6-hexamethylene dilsocyanate (HDI); 1,12-dodecane diisocyanate; cyclobutane-1,3-diisocyanate; cyclohexane-1,3- and -1,4-diisocyanate and any desired mixtures of those isomers; 1-isocyanato-3,3,5-trimethyl-5-isocyanatomethyl-cyclohexane; 2,4- and 2,6-hexahydrotoluene diisocyanate and any desired mixtures of those isomers; hexahydro-1,3- and -1,4-phenylene diisocyanate; perhydro-2,4′- and -4,4′-diphenylmethane diisocyanate; 1,3- and 1,4-phenylene diusocyanate; 1,4-durene diusocyanate (DDT); 4,4′-stilbene diisocyanate; 3,3′-dimethyl-4,4′-biphenylene diisocyanate (TODI); 2,4- and 2,6-toluene diisocyanate (TDI) and any desired mixtures of those isomers. Also suitable are diphenylmethane-2,4′- and/or -4,4′-diisocyanate (MDI) or naphthylene-1,5-diisocyanate (NDI).

Also suitable are, for example: triphenylmethane-4,4′-4″-triisocyanate, polyphenyl-polymethylene polyisocyanates, as are obtained by anilineformaldehyde condensation and subsequent phosgenation and described, for example, in GB-PS 874 430 and GB-PS 848 671. Also suitable are m- and p-isocyanatophenylsulfonyl isocyanates according to U.S. Pat. No. 3,454,606; perchlorinated aryl polyisocyanates, as are described in U.S. Pat. No. 3,277,138; plyisocyanates having carbodiumide groups, as are described in U.S. Pat. No. 3,152,162 and in DE-OS 25 04 400, 25 37 685 and 25 52 350; norbornane diisocyanates according to U.S. Pat. No. 3,492,301; polyisocyanates having allophanate groups, as are described in GB-PS 994 890, BE-PS 761 626 and NL-A 7 102 524; polyisocyanates having isocyanurate groups, as are described in U.S. Pat. No. 3,001,973, in DE-PS 10 22 789, 12 22 067 and 1 027 394 and in DE-OS 1 929 034 and 2 004 048; polyisocyanates having urethane groups, as are described, for example, in BE-PS 752 261 or in U.S. Pat. No. 3,394,164 and 3,644,457; polyisocyanates having acylated urea groups according to DE-PS 1 230 778; polyisocyanates having biuret groups, as are described in U.S. Pat. No. 3,124,605, 3,201,372 and U.S. Pat. No. 3,124,605 and in GB-PS 889 050; polyisocyanates prepared by telomerization reactions, as are described in U.S. Pat. No. 3,654,106; polyisocyanates having ester groups, as are mentioned in GB-PS 965 474 and 1 072 956, in U.S. Pat. No. 3,567,763 and in DE-PS 12 31 688; as well as reaction products of the above-mentioned isocyanates with acetals according to DE-PS 1 072 385; and polyisocyanates containing polymeric fatty acid esters according to U.S. Pat. No. 3,455,883.

It is also possible to use the isocyanate-group-containing distillation residues obtained in the industrial production of isocyanates, optionally dissolved in one or more of the above-mentioned polyisocyanates. It is also possible to use any desired mixtures of the above-mentioned polyisocyanates.

Preference is given to the use of the polyisocyanates that are readily obtainable industrially, for example 2,4- and 2,6-toluene diisocyanate and any desired mixtures of those isomers (TDI); 4,4′-diphenylmethane diisocyanate, 2,4′-diphenylmethane diisocyanate, 2,2′-diphenylmethane duisocyanate and polyphenyl-polymethylene polyisocyanates, as are obtained by aniline-formaldehyde condensation and subsequent phosgenation (crude MDI); and polyisocyanates having carbodiimide groups, uretonimine groups, urethane groups, allophanate groups, isocyanurate groups, urea groups or biuret groups (“modified polyisocyanates”), especially those modified polyisocyanates which are derived from 2,4- and/or 2,6-toluene dilsocyanate or from 4,4′- and/or 2,4′-diphenylmethane diusocyanate. Naphthylene-1,5-diisocyanate and mixtures of the mentioned polyisocyanates are also very suitable.

For the preparation of the PMP's according to the invention, particular preference is given, however, to the use of modified polyisocyanates A2) and isocyanategroup-containing prepolymers A3) prepared by reaction of a polyol component C) and/or a chain extender and/or a crosslinker D) with at least one aromatic diisocyanate from the group of TDI, MDI, TODI, NDI, DDI, more preferably with 4,4′-MDI and/or 2,4-TDI and/or 1,5-NDI. The resulting isocyanate-group-containing prepolymer A3) preferably has an NCO content of from 8 to 45 wt. %, more preferably from 10 to 25 wt. %. The polymer-modifier B) is dissolved in the reaction mixture during the PMP preparation process, as already mentioned in greater detail above.

As already mentioned above, it is possible to use components A1), A2), B), C) and D) for the preparation of the polymer-modified prepolymers (PMP) containing isocyanate groups. According to a form that is preferably used, isocyanate-group-containing PMP prepolymers are prepared from components A1), A2), B) and C).

The prepolymers having isocyanate groups can be prepared in the presence of catalysts. However, it is also possible to prepare the prepolymers having isocyanate groups in the absence of catalysts and to incorporate the catalysts into the reaction mixture only for the preparation of the PUR elastomers.

Polymer modifiers B) suitable for use in the present invention are resin-like, thermoplastic vinyl polymers, especially those having one or more vinyl aromatic monomers such as styrene, α-methylstyrene or a nuclearly substituted styrene having ethylenically unsaturated vinyl monomers such as acrylonitrile, methacrylonitrile, esters of acrylic acid or methacrylic acid, maleic anhydride and N-substituted maleimide, as well as an optional, additionally added diene.

Preferred vinyl polymers include: styrene/acrylonitrile mixtures, α-methyl-styrene/acrylonitrile mixtures, styrene/α-methylstyrene/acrylontrile mixtures, styrene/methyl methacrylate mixtures, styrene/N-phenylmaleimide mixtures, styrene/N-phenylmaleimide/acrylonitrile mixtures.

Particularly preferred vinyl polymers include: styrene/acrylonitrile mixtures, α-methylstyrene/acrylonitrile mixtures and styrene/methyl methacrylate mixtures having preferably from 67 to 84 wt. % vinyl aromatic compound.

The vinyl polymers used in the present invention preferably have number-average molar masses of from 15,000 g/mol to 90,000 g/mol, measured by means of GPC in dichloromethane at 25° C., and limiting viscosities [η] of from 20 to 100 ml/g, measured in dimethylformamide at 25° C.

Such vinyl polymers are widely known. The preparation of such polymers can be carried out by free-radical mass, solution, suspension or emulsion polymerization, optionally with the addition of suitable polymerization initiators. Preferred preparation processes for the vinyl polymers used in the practice of the present invention are solution and suspension polymerization.

The vinyl polymers are often also prepared in the presence of up to 15% of additionally added diene compounds, such as, for example, butadiene, isoprene and ethylene/propylene/diene mixture. In addition to the pure vinyl polymer, such a procedure yields a small amount of vinyl polymer which is bonded chemically to the diene compound and is present in the product in addition to the pure vinyl polymer and does not impair the use according to the invention of the vinyl polymers.

Polyester polyols can be used as the polyol component C). Suitable polyester polyols can be prepared, for example, from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably from 2 to 6 carbon atoms. There come into consideration as dicarboxylic acids, for example: succinic acid, malonic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either individually or in the form of a mixture with one another. Instead of the free dicarboxylic acids, it is also possible to use the corresponding dicarboxylic acid derivatives, such as, for example, dicarboxylic acid monoesters and/or diesters of alcohols having from 1 to 4 carbon atoms, or dicarboxylic acid anhydrides. Preference is given to the use of dicarboxylic acid mixtures of succinic, glutaric and adipic acid in relative proportions of, for example, 20-35/35-65/20-60 parts by weight, respectively, and especially adipic acid. Examples of di- and poly-hydric alcohols are ethanediol, diethylene glycol, 1,2- and 1,3-propanediol, dipropylene glycol, 1,4-butanediol, 1,5-pentanediol, 1,6-hexanediol, neopentyl glycol, 1,10-decanediol, glycerol, trimethylolpropane and pentaerythritol. Preference is given to the use of 1,2-ethanediol, diethylene glycol, 1,4-butanediol, 1,6-hexanediol, glycerol, trimethylolpropane or mixtures of at least two of the mentioned diols, especially mixtures of ethanediol, 1,4-butanediol and 1,6-hexanediol, glycerol and/or trimethylolpropane. It is also possible to use polyester polyols of lactones, for example ε-caprolactone, or hydroxycarboxylic acids, for example o-hydroxycaproic acid and hydroxyacetic acid.

For the preparation of the polyester polyols, the organic (for example, aromatic and preferably aliphatic) polycarboxylic acids and/or polycarboxylic acid derivatives and the polyhydric alcohols can be subjected to polycondensation: without a catalyst or in the presence of esterification catalysts, advantageously in an atmosphere of inert gases (for example, nitrogen, carbon monoxide, carbon dioxide, helium, argon), in solution and also in the melt, at temperatures of from 150 to 300° C., preferably from 180 to 230° C., optionally under reduced pressure, until the desired acid number is reached, which is advantageously less than 10, preferably less than 1.

According to a preferred preparation process, the esterification mixture is subjected to polycondensation at the above-mentioned temperatures to an acid number of from 80 to 30, preferably from 40 to 30, under normal pressure and then under a pressure of less than 500 mbar, preferably from 10 to 150 mbar. Suitable esterification catalysts include: iron, cadmium, cobalt, lead, zinc, antimony, magnesium, titanium and tin catalysts in the form of metals, metal oxides or metal salts. The polycondensation may, however, also be carried out in the liquid phase in the presence of diluents and/or entrainers, such as, for example, benzene, toluene, xylene or chlorobenzene, for the azeotropic distillation of the water of condensation.

For the preparation of the polyester polyols, the organic polycarboxylic acids and/or their derivatives are subjected to polycondensation with polyhydric alcohols advantageously in a molar ratio of 1:1-1.8,-preferably 1:1.05-1.2. The resulting polyester polyols preferably have a functionality of from 1 to 3, especially from 1.8 to 2.4, and a number-average molecular weight of from 400 to 6000, preferably from 800 to 3500.

Suitable polyester polyols also include polycarbonates having hydroxyl groups. As polycarbonates having hydroxyl groups there come into consideration those of the type known per se, which can be prepared, for example, by reaction of diols, such as 1,2-propanediol, 1,3-propanediol, 1,4-butanediol, 1,6-hexanediol, diethylene glycol, trioxyethylene glycol and/or tetraoxyethylene glycol, with dialkyl carbonates, diaryl carbonates (for example, diphenyl carbonate), or phosgene.

In the preparation of the elastomers in accordance with the present invention, difunctional polyester polyols having a number-average molecular weight of from 500 to 6000, preferably from 800 to 3500 and more preferably, from 1000 to 3300 are preferably used.

Polyether polyols and polyether ester polyols are optionally used as component C). Polyether polyols can be prepared by known processes, for example, by anionic polymerization of one or more alkylene oxides in the presence of an alkali hydroxide or alkali alcoholate as a catalyst and with the addition of at least one starter molecule that contains from 2 to 3 reactive hydrogen atoms bonded therein, or by cationic polymerization of one or more alkylene oxides in the presence of a Lewis acid such as antimony pentachloride or boron fluoride etherate. The use of the double-metal cyanide process, which is described in the examples and teaching of U.S. Pat. No. 5,470,813 and U.S. Pat. No. 5,482,908, is also possible. Suitable alkylene oxides contain from 2 to 4 carbon atoms in the alkylene radical. Examples are tetrahydrofuran, 1,2-propylene oxide, 1,2- and 2,3-butylene oxide, with preference being given to the use of ethylene oxide and/or 1,2-propylene oxide. The alkylene oxides can be used individually, alternately in succession, or in the form of mixtures. Mixtures of 1,2-propylene oxide and ethylene oxide are preferably used, with the ethylene oxide being used in amounts of from 10 to 50% in the form of an ethylene oxide end block (“EO-cap”), so that the resulting polyols contain over 70% primary OH end groups. Suitable starter molecules include: water or di- and tri-hydric alcohols, such as ethylene glycol, 1,2-propanediol and 1,3-propanediol, diethylene glycol, dipropylene glycol, 1,4-ethanediol, glycerol, trimethylolpropane, etc. Suitable polyether polyols, preferably polyoxypropylene-polyoxyethylene polyols, have a functionality of from 2 to 4 and number-average molecular weights of from 500 to 8000, preferably from 1500 to 8000.

Also suitable as polyether polyols are polymer-modified polyether polyols, preferably graft polyether polyols, especially those based on styrene and/or acrylonitrile, which are prepared by in situ polymerization of acrylonitrile, styrene or, preferably, mixtures of styrene and acrylonitrile, for example in a weight ratio of from 90:10 to 10:90, preferably from 70:30 to 30:70, in the above-mentioned polyether polyols, as well as polyether polyol dispersions which contain as the disperse phase, usually in an amount of from 1 to 50 wt. %, preferably from 2 to 25 wt. %: e.g. inorganic fillers, polyureas, polyhydrazides, polyurethanes containing tert-amino groups bonded therein, and/or melamine.

It is also possible to use the aminopolyethers having molecular weights and functionalities within the above-specified ranges known per se from polyurethane chemistry, as are described in the examples and teaching of EP-A 0 219 035 and EP-A 0 335 274.

Polyether ester polyols may also be added. They are obtained by propoxylation or ethoxylation of polyester polyols, preferably having a functionality of from 1 to 3, especially from 1.8 to 2.4, and a number-average molecular weight of from 400 to 8000, preferably from 800 to 6000.

It is also possible to use polyether ester polyols which are obtained by esterification of polyether polyols, prepared by the above-described process, with organic dicarboxylic acids such as those listed above and alcohols having a functionality of two or more. Such polyether ester polyols preferably have a functionality of from 1 to 3, especially from 1.8 to 2.4, and a number-average molecular weight of from 400 to 8000, preferably from 800 to 6000.

For the preparation of the polyurethanes according to the invention there may additionally be used as component D) low molecular weight difunctional chain extenders, tri- or tetra-functional crosslinkers, or mixtures of chain extenders and crosslinkers.

Such chain extenders and crosslinkers D) are used to modify the mechanical properties, especially the hardness, of the polyurethanes. Suitable chain extenders include alkanediols, dialkylene glycols and polyalkylene polyols, and crosslinkers, for example, tri- or tetra-hydric alcohols and oligomeric polyalkylene polyols having a functionality of from 3 to 4, usually have molecular weights<800, preferably from 18 to 400 and more preferably from 60 to 300. As chain extenders, there are preferably used alkanediols having from 2 to 12 carbon atoms, preferably 2, 4 or 6 carbon atoms, for example ethanediol, 1,6-hexanediol, 1,7-heptanediol, 1,8-octanediol, 1,9-nonanediol, 1,1,0-decanediol and especially 1,4-butanediol and dialkylene glycols having from 4 to 9 carbon atoms, for example diethylene glycol and dipropylene glycol, as well as polyoxyalkylene glycols. Also suitable are branched-chain and/or unsaturated alkanediols usually having not more than 12 carbon atoms, such as, for example, 1,2-propanediol, 2-methyl 1,3-propanediol, 2,2-dimethyl-1,3-propanediol, 2-butyl-2-ethyl-1,3-propanediol, 2-butene-1,4-diol and 2-butyne-1,4-diol; diesters of terephthalic acid with glycols having from 2 to 4 carbon atoms, such as, for example, terephthalic acid bisethylene glycol or terephthalic acid bis-1,4-butanediol; hydroxyalkylene ethers of hydroquinone or of resorcinol, for example 1,4-di-(β-hydroxyethyl)-hydroquinone or 1,3-(β-hydroxyethyl)-resorcinol; alkanolamines having from 2 to 12 carbon atoms, such as ethanolamine, 2-aminopropanol and 3-amino-2,2-dimethylpropanol; N-alkyldialkanolamines, for example N-methyl- and N-ethyldiethanolamine; (cyclo)aliphatic diamines having from 2 to 15 carbon atoms, such as 1,2-ethylenediamine, 1,3-propylenediamine, 1,4-butylenediamine and 1,6-hexamethylenediamine, isophoronediamine, 1,4-cyclohexamethylenediamine and 4,4′-diaminodicyclohexylmethane; N-alkyl-substituted, N,N′-dialkyl-substituted and aromatic diamines, which may also be substituted on the aromatic radical by alkyl groups, having from 1 to 20 carbon atoms, preferably from 1 to 4 carbon atoms, in the N-alkyl radical, such as N,N′-diethyl-, N,N′-di-sec-pentyl-, N,N′-disec-hexyl-, N,N′-di-sec-decyl- and N,N′-dicyclohexyl-, (p- and m-) -phenylenediamine, N,N′-dimethyl-, N,N′-diethyl-, N,N′-diisopropyl-, N,N′-di-sec-butyl-, N,N′-dicyclohexyl-, -4,4′-diamino-diphenylmethane, N,N′-di-sec-butylbenzidine, methylene-bis(4-amino-3-benzoic acid methyl ester), 2,4-chloro-4,4′-diamino-diphenylmethane, 2,4- and 2,6-toluenediamine.

The compounds of component D) can be used in the form of mixtures or individually. The use of mixtures of chain extenders and crosslinkers is also possible.

The hardness of the polyurethane is adjusted by the combination of components A) and B) with components C) and D), and also by the variation of components C) and D) in relatively broad relative proportions, the hardness increasing as the content of components A), B) and D) in the reaction mixture rises.

In order to obtain a desired hardness of the polyurethane, the required amounts of components A) to D) can be determined in a simple manner by experiment. There are advantageously used from 0.2 to 50 parts by weight, preferably from 0.5 to 30 parts by weight, of the polymer modifier B), based on 100 parts by weight of component A). There are also advantageously used from 1 to 50 parts by weight, preferably from 3 to 20 parts by weight, of the chain extender and/or crosslinker D), based on 100 parts by weight of component C).

As component E) there may be used amine catalysts known to the person skilled in the art, for example tertiary amines, such as triethylamine, tributylamine, N-methyl-morpholine, N-ethyl-morpholine, N,N,N′,N′-tetramethyl-ethylenediamine, pentamethyl-diethylenetriamine and higher homologues (DE-OS 26 24 527 and 26 24 528), 1,4-diaza-bicyclo-[2.2.2]-octane, N-methyl-N′-dimethylaminoethyl-piperazine, bis-(dimethylaminoalkyl)-piperazines, N,N-dimethylbenzylamine, N,N-dimethylcyclohexylamine, N,N-diethylbenzylamine, bis-(N,N-diethylaminoethyl) adipate, N,N,N′,N′-tetramethyl-1,3-butanediamine, N,N-dimethyl-β-phenyl-ethyl-amine, bis-(dimethylaminopropyl)-urea, 1,2-dimethylimidazole, 2-methylimidazole, monocyclic and bicyclic amidines, bis-(dialkylamino)alkyl ethers, and also tertiary amines having amide groups (preferably formamide groups) according to DE-OS 25 23 633 and 27 32 292. Suitable catalysts are also known Mannich bases of secondary amines, such as dimethylamine, and aldehydes, preferably formaldehyde, or ketones, such as acetone, methyl ethyl ketone or cyclohexanone, and phenols, such as phenol, nonylphenol or bisphenol. Tertiary amines containing hydrogen atoms active towards isocyanate groups useful as catalysts are, for example, triethanolamine, triisopropanolamine, N-methyl-diethanolamine, N-ethyl-diethanolamine, N,N-dimethyl-ethanolamine, reaction products thereof with alkylene oxides, such as propylene oxide and/or ethylene oxide, as well as secondary-tertiary amines according to DE-OS 27 32 292. It is also possible to use as catalysts silamines having carbon-silicon bonds, as are described in U.S. Pat. No. 3,620,984, for example 2,2,4-trimethyl-2-silamorpholine and 1,3-diethyl-aminomethyl-tetramethyldisiloxane. Also suitable are nitrogen-containing bases, such as tetraalkylammonium hydroxides, and also hexahydrotriazines. The reaction between NCO groups and Zerewitinoff-active hydrogen atoms is also greatly accelerated by lactams and azalactams. According to the invention, the concomitant use of organic metal compounds, especially organic tin compounds, as additional catalysts is also possible. Suitable organic tin compounds, in addition to sulfur-containing compounds, such as di-n-octyl-tin mercaptide, are preferably tin(II) salts of carboxylic acids, such as tin(II) acetate, tin(II) octoate, tin(II) ethylhexoate and tin(II) laurate, and tin(IV) compounds, for example dibutyltin oxide, dibutyltin dichloride, dibutyltin diacetate, dibutyltin dilaurate, dibutyltin maleate or dioctyltin diacetate.

The catalysts or catalyst combinations are generally used in an amount of approximately from 0.001 to 10 wt. %, preferably from 0.05 to 2 wt. %, based on the total amount of components C) and D).

By means of the process according to the invention, it is possible, in the absence of moisture and blowing agents having physical or chemical action, to prepare compact PUR elastomers, for example PUR casting elastomers.

For the preparation of cellular, preferably microcellular, PUR elastomers there is used as blowing agent preferably water vi), which reacts in situ with the organic polyisocyanates or with prepolymers having isocyanate groups to form carbon dioxide and amino groups, which in turn react further with further isocyanate groups to form urea groups and thus act as chain extenders.

If water must be added to the polyurethane formulation in order to establish the desired density, it is usually used in amounts of from 0.001 to 5.0 wt. %, preferably from 0.01 to 3.0 wt. % and more preferably from 0.05 to 1.5 wt. %, based on the weight of the structural components A), B), C), D) and optionally E).

Instead of water vi), or preferably in combination with water, it is possible to use as blowing agent gases or readily volatile inorganic or organic substances, and mixtures thereof, which evaporate under the effect of the exothermic polyaddition reaction and advantageously have a boiling point under normal pressure in the range of from −40 to 120° C., preferably from −27 to 90° C., as physical blowing agents. Suitable organic blowing agents are, for example, acetone, ethyl acetate, halo-substituted alkanes or perhalogenated alkanes such as R134a, R141b, R365mfc, R245fa, R227ea, also butane, pentane, cyclopentane, hexane, cyclohexane, heptane or diethyl ethers. Suitable inorganic blowing agents are, for example air, CO₂ or N₂O. A blowing action can also be achieved by addition of compounds that decompose at temperatures above room temperature with the liberation of gases, for example of nitrogen and/or carbon dioxide, such as azo compounds, e.g. azodicarbonamide or azoisobutyric acid nitrile, or salts such as ammonium bicarbonate, ammonium carbamate or ammonium salts of organic carboxylic acids, for example the monoammonium salts of malonic acid, boric acid, formic acid or acetic acid. Further examples of blowing agents and details relating to the use of blowing agents are described in R. Vieweg, A. Höchtlen (eds.): “Kunststoff-Handbuch”, Volume VII, Carl-Hanser-Verlag, Munich, 3rd Edition, 1993, p. 115-118, 710-715.

The amount of solid blowing agents, low-boiling liquids or gases advantageously to be used, each of which may be used individually or in the form of mixtures (for example, in the form of liquid or gas mixtures or in the form of gas/liquid mixtures), depends on the desired density and the amount of water used. The required amounts can readily be determined by experiment. Satisfactory results are usually obtained with solids amounts of from 0.5 to 35 wt. %, preferably from 2 to 15 wt. %, liquid amounts of from 0.1 to 30 wt. %, preferably from 0.2 to 10 wt. %, and/or gas amounts of from 0.01 to 80 wt. %, preferably from 0.2 to 50 wt. %, in each case based on the weight of the structural components A), B), C), D) and optionally E). Loading with gas, for example with air, carbon dioxide, nitrogen and/or helium, can be carried out either via component C), optionally in combination with component D) and/or E) and F), or via the polymer-modified polyisocyanate (PMP).

Further additives F) may optionally be incorporated into the reaction mixture for the preparation of the compact and cellular PUR elastomers. Examples which may be mentioned are surface-active additives, such as emulsifiers, foam stabilizers, cell regulators, flameproofing agents, nucleating agents, oxidation retarders, stabilizers, lubricants and mold release agents, colorants, dispersion aids and pigments. Suitable emulsifiers are, for example, the sodium salts of castor oil sulfonates or salts of fatty acids with amines, such as the oleate of diethylamine or the stearate of diethanolamine. Alkali or ammonium salts of sulfonic acids, such as, for example, of dodecylbenzenesulfonic acid or dinaphthylmethanedisulfonic acid, or of fatty acids, such as ricinoleic acid, or of polymeric fatty acids may also be used concomitantly as surface-active additives. Suitable foam stabilizers are especially polyether siloxanes, especially water-soluble examples thereof. The structure of these compounds is generally such that a copolymer of ethylene oxide and propylene oxide is bonded to a polydimethylsiloxane radical. Such foam stabilizers are described, for examrple, in U.S. Pat. No. 2,834,748, 2,917,480 and 3,629,308. Of particular interest are polysiloxane-polyoxyalkylene copolymers multiply branched via allophanate groups, according to DE-OS 25 58 523. Also suitable are other organopolysiloxanes, oxyethylated alkylphenols, oxyethylated fatty alcohols, paraffin oils, castor oil or ricinoleic acid esters, Turkey-red oil, groundnut oil and cell regulators such as paraffins, fatty alcohols and poly-dimethylsiloxanes. Oligomeric polyacrylates having polyoxyalkylene and fluoroalkane radicals as side groups are also suitable for improving the emulsifying action, the dispersion of the filler, the cell structure and/or for the stabilization thereof. The surface-active substances are usually used in amounts of from 0.01 to 5 parts by weight, based on 100 parts by weight of the higher molecular weight polyhydroxyl compounds C) and D). It is also possible to add reaction retarders, also pigments or colorings, and flameproofing agents and antistatics known per se, also stabilizers against the effects of ageing and weathering, plasticizers, viscosity regulators, and substances having a fungistatic and bacteriostatic action.

Further examples of surface-active additives and foam stabilizers, as well as cell regulators, reaction retarders, stabilizers, flame-retarding substances, antistatics, plasticizers, colorings and fillers, as well as substances having a fungistatic and bacteriostatic action, which may optionally be used concomitantly, and details relating to the use and mode of action of such additives are described in R. Vieweg, A. Höchtlen (eds.): “Kunststoff-Handbuch”, Volume VII, Carl-Hanser-Verlag, Munich, 3rd Edition, 1993, p. 118-124.

For the preparation of the polyurethanes according to the invention, the components are reacted in amounts such that the equivalence ratio of the NCO groups of the polyisocyanates (PMP) to the sum of the hydrogen atoms, reactive towards isocyanate groups, of components C), D), E) and F) and of any blowing agents having a chemical action which may have been used, is from 0.8:1 to 1.2:1, preferably from 0.9:1 to 1.15:1 and more preferably from 0.95:1 to 1.05:1.

The polyurethanes according to the invention can be prepared by the processes described in the literature, for example the one-shot, the semi-prepolymer or the prepolymer process, with the aid of mixing apparatus known in principle to the person skilled in the art. They are preferably prepared by the prepolymer process.

In one of the methods for preparation of the PUR materials accordingito the invention, the starting components are homogeneously mixed in the absence of blowing agents, usually at a temperature of from 20 to 80° C., preferably from 25 to 60° C., and the reaction mixture is introduced into an open, optionally temperature-controlled molding tool and allowed to cure. In another method for the preparation of the PUR elastomers according to the invention, the structural components are mixed in the same manner in the presence of blowing agents, preferably water, and introduced into the optionally temperature-controlled molding tool. After filling, the molding tool is closed, and the reaction mixture is allowed to foam with densification, for example with a degree of densification (ratio of the density of the moulding to the density of the free foam) of from 1.05 to 8, preferably from 1.1 to 6 and more preferably, from 1.2 to 4, to form molded articles. As soon as the molded articles are sufficiently strong, they are removed from the mold. The mold removal times are dependent inter alia on the temperature and geometry of the molding tool and the reactivity of the reaction mixture, and are usually from 1 to 10 minutes.

Compact PUR elastomers according to the invention have, depending inter alia on the content and type of filler, a density of from 0.8 to 1.4 g/cm³, preferably from 0.9 to 1.25 g/cm³. Cellular PUR elastomers according to the invention have densities of from 0.1 to 1.4 g/cm³, preferably from 0.15 to 0.8 g/cm³.

The polyurethanes produced in accordance with the present invention are especially valuable raw materials for molding plastics, which are distinguished, compared with conventionally used raw materials, by an equivalent or even increased hardness, despite the fact that the density of the molding is reduced. Such raw materials are used also in the manufacture of components for shoes or of shoe soles of single- or multi-layer construction.

Having thus described our invention, the following Examples are given as being illustrative thereof.

### EXAMPLES

### General Procedure

The polyurethane test specimens were produced by mixing component A containing isocyanate groups at 45° C. with component B at 45° C. in a low-pressure processing machine, for example, a PSA 95 from Klöckner DESMA Schuhmaschinen GmbH, metering the mixture into an aluminum mold (size 200×200×10 mm) adjusted to a temperature of 50° C., closing the mold and removing the elastomer from the mold after 3 minutes.

The strength of the material upon removal from the mold, the so-called green strength, was tested by bending the sheet at an angle of 1800 for 10 seconds. The site of bending was assessed visually for being undamaged (++), for being cracked (+/−) or for being broken (−).

The hardness of the elastomer sheets so produced was measured after 24 hours' storage using a Shore A type hardness measuring device in accordance with DIN 53 505.

In the Examples mentioned, polymer-modified polyisocyanates and polymer-modified prepolymers containing isocyanate were used. The vinyl polymer used was a powder, styrene/acrylonitrile polymer (styrene/acrylonitrile copolymer) having an acrylonitrile content of 28.0% and a number-average molecular weight Mn of 39,000 g/mol.

1. Polymer-modified Polyisocyanate (PMP1):

80 parts by weight of 4,4-diisocyanatodiphenylmethane were stirred for 2 hours at 700° C., under nitrogen, with 20 parts by weight of the styrene/acrylonitrile copolymer. The polymer dissolved completely, yielding a clear product which was stable to storage and had the following characteristic data:

NCO content=26.9%

Viscosity at 50° C.=5000 mPa·s

2. Polymer-modified Polyisocyanate (PMP2):

87.0 parts by weight of 4,4-diisocyanatodiphenylmethane were heated for 2 hours at 80° C., under nitrogen, with 13.0 parts by weight of tripropylene glycol. The resulting product was a clear liquid.

95 parts by weight of the above-descnrbed product were stirred for 2 hours at 80° C., under nitrogen, with 5 parts by weight of the styrene/acrylonitrile copolymer. The polymer dissolved completely, yielding a clear product which was stable to storage and had the following characteristic data:

NCO content=21.6%

Viscosity at 50° C.=1210 mPa·s

3. Modified Polyisocyanate (MP3, Comparison):

87.0 parts by weight of 4,4-diisocyanatodiphenylmethane were heated for 2 hours at 80° C., under nitrogen, with 13.0 parts by weight of tripropylene glycol. The resulting product was a clear liquid having the following characteristic data:

NCO content=23.5%

Viscosity at 25° C.=600 mPa·s

4. Polymer-modified Isocyanate Prepolymer (PMP4):

60.0 parts by weight of 4,4-diisocyanatodiphenylmethane and 6.5 parts by weight of carbodiimide-modified 4,4′-MDI were mixed at 50° C. with 23.5 parts by weight of polyethylenebutylene adipate, OH number 56, and heated for 2 hours at 80° C., under nitrogen.

NCO content=23.3%

10 parts by weight of the styrene/acrylonitrile copolymer were then added, and the whole mixture was again heated for 2 hours at 80° C., under nitrogen. The polymer dissolved completely, yielding a clear product which was stable to storage and had the following characteristic data:

NCO content=21.0%

Viscosity at 25° C.=13,000 mPa·s

5. Isocyanate Prepolymer (MP5, Comparison):

60.0 parts by weight of 4,4-diisocyanatodiphenylmethane (NCO content 33.6%) and 6.5 parts by weight of carbodiimide-modified 4,4′-MDI were mixed at 50° C. with 33.5 parts by weight of polyethylenebutylene adipate, OH number 56, and heated for 2 hours at 80° C., under nitrogen. The resulting product was a clear liquid having the following characteristic data:

NCO content=20.7%

Viscosity at 20° C.: about 1000 mPa·s

6. Polymer-modified Isocyanate Prepolymer (PMP6):

56.0 parts by weight of 4,4-diisocyanatodiphenylmethane and 6.0 parts by weight of carbodiumide-modified 4,4′-MDI were mixed at 50° C. with 23 parts by weight of polyethylenebutylene adipate, OH number 56, and 5.0 parts by weight of polyoxypropyleneoxyethylene block copolyether diol, OH number 28, and heated for 2 hours at 80° C., under nitrogen.

10 parts by weight of the styrene/acrylonitrile copolymer were then added and the whole was again heated for 2 hours at 80° C., under nitrogen. The polymer dissolved completely, yielding a clear product which was stable to storage.

NCO content=19.5%

The following materials were used as the polyol components:

1. Polyester polyol (C1), a linear polyethylenebutylene adipate, OH number: 55.

2. Polyester polyol (C2), a linear polyethylenebutylenecarboxylic acid ester based on commercial glutaric acid, OH number: 55.

3. Polyether polyol (C3), a linear polyoxypropyleneoxyethylene block copolyether diol, OH number: 28.

### Processing Examples

### Example 1

The prepolymer (PMP4) was processed by the above-described General Procedure with the following mixture (G1):

90.85 wt. % polyol (C1)

7.20 wt. % ethanediol

0.70 wt. % triethanolamine

0.45 wt. % diazabicyclo[2,2,2]octane

0.40 wt. % water

0.40 wt. % foam stabilizer DC 193 from Air Products.

The mixing ratio of components (G1) to (PMP4) was 100:74 parts by weight, and the resulting molding density was 480 kg/m³. The test specimens, which can be removed from the mold after a molding time of only 3.5 minutes, had a positive bending test (++) and a Shore A hardness of 57.

### Example 2

The prepolymer (MP5) was processed by the General Procedure with the mixture (G1) as described in Example 1. The mixing ratio of components (G1) to (MP5) was 100:72 parts by weight, and the resulting molding density was 480 kg/m³. The test specimens, which could be removed from the mold only after a molding time of 4.0 minutes, had a positive bending test (++) and a Shore A hardness of 45.

### Example 3

The prepolymer (PMP4) was processed by the General Procedure with the following mixture (G2):

87.90 wt. % polyol (C2)

10.18 wt. % ethanediol

0.70 wt. % triethanolamine

0.44 wt. % diazabicyclo[2,2,2]octane

0.39 wt. % water

0.39 wt. % foam stabilizer DC 193 from Air Products.

The mixing ratio of components (G2) to (PMP4) was 100:92 parts by weight, and the resulting molding density was 500 kg/m³. The test specimens, removed from the mold after 4minutes, had a positive bending test (++) as well as a Shore A hardness of 74.

### Example 4

The prepolymer (MP5) was processed by the General Procedure with the mixture (G2) as described in Example 3. The mixing ratio of components (G2) to (MP5) was 100:91 parts by weight, and the resulting molding density was 500 kg/m³.

The test specimens, which could be removed from the mold only after 4.5 minutes with a positive bending test (++), had a Shore A hardness of 64.

### Example 5

The prepolymer (PMP4) was processed by the General Procedure with the following mixture (G3):

87.25 wt. % polyol (C3)

11.00 wt. % butanediol

0.20 wt. % triethanolamine

0.60 wt. % diazabicyclo[2,2,2]octane

0.40 wt. % water

0.05 wt. % dibutyltin dilaurate

0.50 wt. % foam stabilizer DC 193 from Air Products.

The mixing ratio of components (G3) to (PMP4) was 100:67 parts by weight, and the resulting molding density was 500 kg/m³. The test specimens had a Shore A hardness of 41.

### Example 6

The prepolymer (MP5) was processed by the General Procedure with the mixture (G3) as described in Example 5. The mixing ratio of components (G3) to (MP5) was 100:68 parts by weight, and the resulting molding density was 500 kg/m³. The test specimens had a Shore A hardness of 36.

### Example 7

The prepolymer (PMP2) was processed by the General Procedure with the following mixture (G4):

93.28 wt. % polyol (C3)

5.00 wt. % ethanediol

0.8 wt. % triethanolamine

0.4 wt. % diazabicyclo[2,2,2]octane

0.5 wt. % water

0.02 wt. % dibutyltin dilaurate.

The mixing ratio of components (C4) to (PMP2) was 100:52 parts by weight, and the resulting molding density was 400 kg/m³. The test specimens had a Shore A hardness of 34.

### Example 8

The prepolymer (MP3) was processed by the General Procedure with the mixture (G4) as described in Example 7. The mixing ratio of components (G4) to (MP3) was 100:48 parts by weight, and the resulting molding density was 400 kg/m³. The test specimens had a Shore A hardness of 31.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polymer-modified polyisocyanate comprising:
A) at least one polyisocyanate component selected from the group consisting of
A1) polyisocyanate components having an NCO content of from 15 to 50 wt. %,
A2) modified polyisocyanate components having an NCO content of from 12 to 45 wt. %,
A3) isocyanate-containing prepolymers having an NCO content of from 8 to 45 wt. %, obtainable from
i) A1) and/or A2),
ii) one or more polyol components C),
iii) optionally, one or more chain extenders and/or crosslinkers D), and
B) a thermoplastic vinyl polymer having a number-average molecular weight of from 15 to 90 kg/mol
and, optionally, further additives and/or added substances.

2. A polymer-modified polyurethane which is the reaction product of
i) the polymer-modified polyisocyanate of claim 1,
ii) at least one polyol and/or polyamine component (C) having a number-average molecular weight of from 800 to 8000 daltons and a functionality of from 1.8 to 3.5 selected from the group consisting of polyether polyols, polyether polyamines, polyester polyols, polyether ester polyols, polycarbonate diols and polycaprolactones,
iii) at least one chain extender and/or crosslinker D) having a number-average molecular weight of from 60 to 400 daltons and a functionality of from 2 to 4, optionally, in the presence of
iv) a catalyst E),
v) a further additive and/or added agent F), and
vi) water and/or another blowing agent.

3. A compact polyurethane molded article having a density of from 0.8 to 1.4 g/cm³ produced from the polymer-modified polyurethane of claim 2.

4. A cellular polyurethane molded article having a density of from 0.1 to 1.4 g/cm³ produced from the polymer-modified polyurethane of claim 2.
